(19) United States
(12) Patent Application Publication
(10) Pub. No.: US 2008/0285959 A1
(43) Pub. Date: Nov. 20, 2008

(54) Portable reception device

(75) Inventor: Naoki Yamamoto, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 12/149,788

(22) Filed: May 8, 2008

(30) Foreign Application Priority Data
May 15, 2007 (JP) 2007-128841

(51) Int. Cl. H04N 7/26

(52) U.S. Cl. 386/124

(57) ABSTRACT

A portable reception device that is portably designed, and that receives television broadcast and feeds the received video information to a monitor so that video is viewed from outside, the portable reception device includes: a reception section receiving television broadcast; a video display section feeding the video information received through the reception section to the monitor; a video storage section storing the video information received through the reception section; a reception check section checking whether or not television broadcast can be received through the reception section; a reception process check section checking whether or not television broadcast is being received through the reception section; and a video recording section receiving television broadcast on a channel preset through the reception section and writing the received video information in the video storage section if television broadcast is found to be receivable by the reception check section and television broadcast is found not to be being received by the reception process check section.

This application is based on Japanese Patent Application No. 2007-128841 filed on May 15, 2007, the contents of which are hereby incorporated by reference.

### BACKGROUND OF THE INVENTION

1. Field of the Invention

The present invention relates to a portable reception device that is portably designed, and that receives television broadcast and feeds the received video information to a monitor so that the video is viewed from outside.

2. Description of Related Art

For use in portable reception devices, such as a mobile telephone, that are portable, and that receive television broadcast and feed the received video information to a monitor so that the video is viewed from outside, various devices, methods, etc. for recording the received video information have been proposed.

For example, a mobile telephone has been disclosed (see JP-A-2006-186673) that performs the following procedure. When a timer section detects the time at which to check whether or not recording is possible, in order to check the reception status of a channel for a program that is recorded according to the program stored in a memory section, a check signal is received from a tuner section and a demodulation section, so that whether or not recording is possible is checked; if it is found to be impossible to make the programmed recording, a user who programmed the recording is notified of the present situation. With the mobile telephone described above, a sufficient time before the programmed recording is started, a user can take a corrective action, as by improving the reception status or using another device for recording by the time when the programmed recording is started.

In order to make so-called programmed recording, however, a conventional portable reception device such as the mobile telephone described above needs to be programmed to record a particular program through EPG (electronic program guide) or the like; such a programming operation may be complicated. Even when recording is programmed, it may be unsuccessful due to poor reception, with the result that, when a user desires to view the television broadcast program to be recorded, the user cannot view it since the program was not recorded.

### SUMMARY OF THE INVENTION

An object of the present invention is to provide a portable reception device that can record television broadcast with enhanced user convenience.

To achieve the above object, according to the present invention, a portable reception device that is portably designed, and that receives television broadcast and feeds the received video information to a monitor so that video is viewed from outside, the portable reception device includes: a reception section receiving television broadcast; a video display section feeding the video information received through the reception section to the monitor; a video storage section storing the video information received through the reception section; a reception check section checking whether or not television broadcast can be received through the reception section; a reception process check section checking whether or not television broadcast is being received through the reception section; and a video recording section receiving television broadcast on a channel preset through the reception section and writing the received video information in the video storage section if television broadcast is found to be receivable by the reception check section and is found not to be being received by the reception process check section.

With this configuration, television broadcast is received through the reception section, and the received video information is fed to the monitor. Moreover, whether or not television broadcast can be received through the reception section is checked, and whether or not television broadcast is being received through the reception section is checked. Then, if television broadcast is found to be receivable and is found not to be being received, television broadcast on a channel preset through the reception section is received, and the received video information is written in the video storage section. Thus, it is possible to record television broadcast with enhanced user convenience.

That is, if television broadcast is found to be receivable and is found not to be being received (if television broadcast can be received but is not being viewed), television broadcast on a channel preset through the reception section is received, and the received video information is written in the video storage section; hence, a user does not need to program recording or the like. Thus, it is possible to record television broadcast with enhanced user convenience.

The portable reception device configured as described above according to the present invention may include a video selection section receiving an operational input from outside and selecting, based on the received operational input, one piece of video information from multiple pieces of video information stored in the video storage section. Here, the video display section reads, from the video storage section, the one piece of video information selected by the video selection section and feeds the one piece of video information to the monitor.

With this configuration, an operational input from outside is received, one piece of video information is selected from multiple pieces of video information stored in the video storage section based on the received operational input, and the selected one piece of video information is read from the video storage section and is fed to the monitor. Thus, it is possible to view television broadcast with enhanced user convenience.

The portable reception device configured as described above according to the present invention may include: a genre setting section receiving an operational input from outside and setting genre information based on the received operational input; a genre acquisition section obtaining EPG (electronic program guide) information through the reception section and extracting genre information of a receivable program from the EPG information obtained; and a program selection section selecting, based on the genre information obtained by the genre acquisition section, a program having genre information corresponding to the genre information set by the genre setting section from programs that can be received through the reception section. Here, the television broadcast is digital television broadcast, and the video recording section receives digital television broadcast of the program selected by the program selection section and writes the received video information in the video storage section.

With this configuration, the television broadcast is digital television broadcast; an operational input from outside is received and genre information is set based on the received operational input. Then, EPG (electronic program guide) information is obtained through the reception section, and genre information of a receivable program from the EPG information obtained is extracted. Then, based on the genre information obtained, a program having genre information corresponding to the genre information set by the genre setting section is selected from programs that can be received through the reception section, and the digital television broadcast of the selected program is received, and the received video information is written in the video storage section. Thus, it is possible to record television broadcast with further enhanced user convenience.

That is, based on the genre information obtained, a program having genre information corresponding to preset genre information is selected from programs that can be received through the reception section, and television broadcast of the selected program is received and the received video information is written in the video storage section; hence, when the genre of programs that a user desires to view is set, the programs of the genre desired by the user are recorded. Thus, it is possible to record television broadcast with further enhanced user convenience.

The portable reception device configured as described above according to the present invention may include a video deletion section deleting, when amount of video information stored in the video storage section reaches a predetermined first upper limit, the video information stored in the video storage section in the order in which the video information is stored in the video storage section by the video recording section until the amount of video information stored in the video storage section reaches a predetermined second upper limit less than the first upper limit.

With this configuration, when the amount of video information stored in the video storage section reaches a predetermined first upper limit, the video information stored in the video storage section is deleted in the order in which the video information is stored in the video storage section until the amount of video information stored in the video storage section reaches a predetermined second upper limit less than the first upper limit. Thus, it is possible to record television broadcast with still further enhanced user convenience.

That is, when the amount of video information stored in the video storage section reaches a predetermined first upper limit, the video information stored in the video storage section is deleted in the order in which the video information is stored in the video storage section until the amount of video information stored in the video storage section reaches a predetermined second upper limit less than the first upper limit; hence, the amount of video information stored in the video storage section can be regulated to be equal to or more than the second upper limit but equal to or less than the first upper limit, and the capacity of the video storage section can be used effectively. Thus, by appropriately setting the first and second upper limits, it is possible to record television broadcast with still further enhanced user convenience.

### BRIEF DESCRIPTION OF THE DRAWINGS

FIG. 1 is a block diagram showing an example of the configuration of a portable television set according to the present invention;

FIG. 2 is a block diagram showing an example of the configuration of main portions of the portable television set according to the invention;

FIG. 3 is a flow chart (the first half) showing an example of the operation of the portable television set (mostly CPU);

FIG. 4 is a flow chart (the latter half) showing the example of the operation of the portable television set (mostly CPU); and

FIG. 5 is a screen diagram showing an example of a recorded program playback screen displayed on a display in step S117 in the flow chart shown in FIG. 4.

### DETAILED DESCRIPTION OF PREFERRED EMBODIMENTS

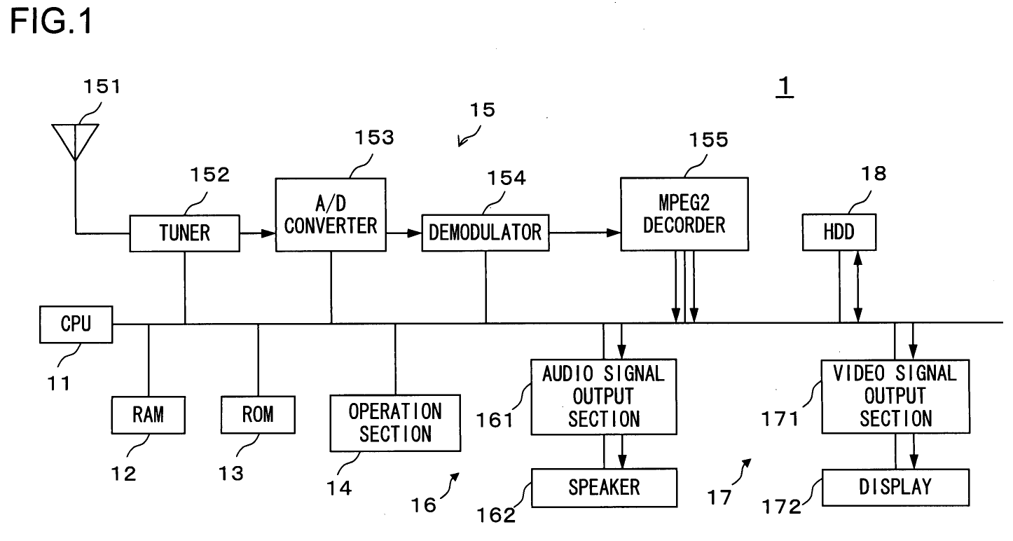

Hereinafter, an embodiment of the present invention will be described with reference to the accompanying drawings. FIG. 1 is a block diagram showing an example of the configuration of a portable television set according to the invention. The portable television set 1 (corresponding to a portable reception device) is portable (compact and lightweight); it receives an operational input from a user through an operation section 14, which will be described later, then receives digital television broadcast based on the received operational input and then displays the received video information on a display 172 and feeds the received audio information to a speaker 162.

The portable television set 1 includes a CPU 11, a RAM 12, a ROM 13, the operation section 14, a reception section 15, an audio output section 16, an image output section 17 and a HDD 18.

The CPU (central processing unit) 11 controls the overall operation of the portable television set 1. The RAM (random access memory) 12 stores different pieces of information such as setting information so that it can be freely read and written. The ROM (read only memory) 13 stores programs such as a control program that operates the CPU 11.

The operation section 14 receives various operations such as the on-off operation of a power supply and channel selection. The reception section 15 receives and demodulates television broadcast. The reception section 15 includes an antenna 151, a tuner 152, an analog-to-digital converter 153, a demodulator 154 and a MPEG-2 decoder 155.

The antenna 151 receives television broadcast waves. The tuner 152 selects television broadcast on a channel preset (or set through the operation section 14) from the television broadcast waves received by the antenna 151. The analog-to-digital converter 153 converts signals (analog signals) outputted from the tuner 152 into digital information. The demodulator 154 demodulates the information outputted from the analog-to-digital converter 153. The MPEG-2 (motion picture experts group) decoder 155 decodes the information demodulated and outputted by the demodulator 154 into the video information before compression.

The audio output section 16 feeds audio signals of the television broadcast received by the reception section 15 to the speaker 162; it includes an audio signal output section 161 and the speaker 162. The audio signal output section 161 feeds audio information outputted from the demodulator 154 to the speaker 162. The speaker 162 outputs sound corresponding to the audio signals inputted from the audio signal output section 161.

The image output section 17 displays on the display 172 video corresponding to the video information decoded by the MPEG-2 decoder 155; it includes a video signal output section 171 and the display 172. The video signal output section 171 feeds the video information outputted from the MPEG-2 decoder 155 to the display 172. The display 172 (corresponding to a monitor) includes a display such as a LCD (liquid crystal display) or a PDP (plasma display panel); it displays the video corresponding to the video information inputted from the video signal output section 171.

The HDD (hard disk drive) 18 has a capacity of, for example, 40 GB (gigabytes); it stores video information or the like received through the reception section 15.

A description will now be given of how the portable television set 1 operates to receive television broadcast. A transmitted digital broadcast wave is first received by the antenna 151. When a selection operation is received through the operation section 14, the tuner section 152 switches over to a transponder for reception. The received digital broadcast wave is converted into digital information by the analog-to-digital converter 153, and the digital information is demodulated by the demodulator 154 into video and audio information. The video information demodulated by the demodulator 154 is decoded by the MPEG-2 decoder 155 into the video information before compression, and this video information is fed through the video signal output section 171 to the display 172, where the video is displayed. The audio information demodulated by the demodulator 154 is fed through the audio signal output section 161 to the speaker 162, where the sound is outputted.

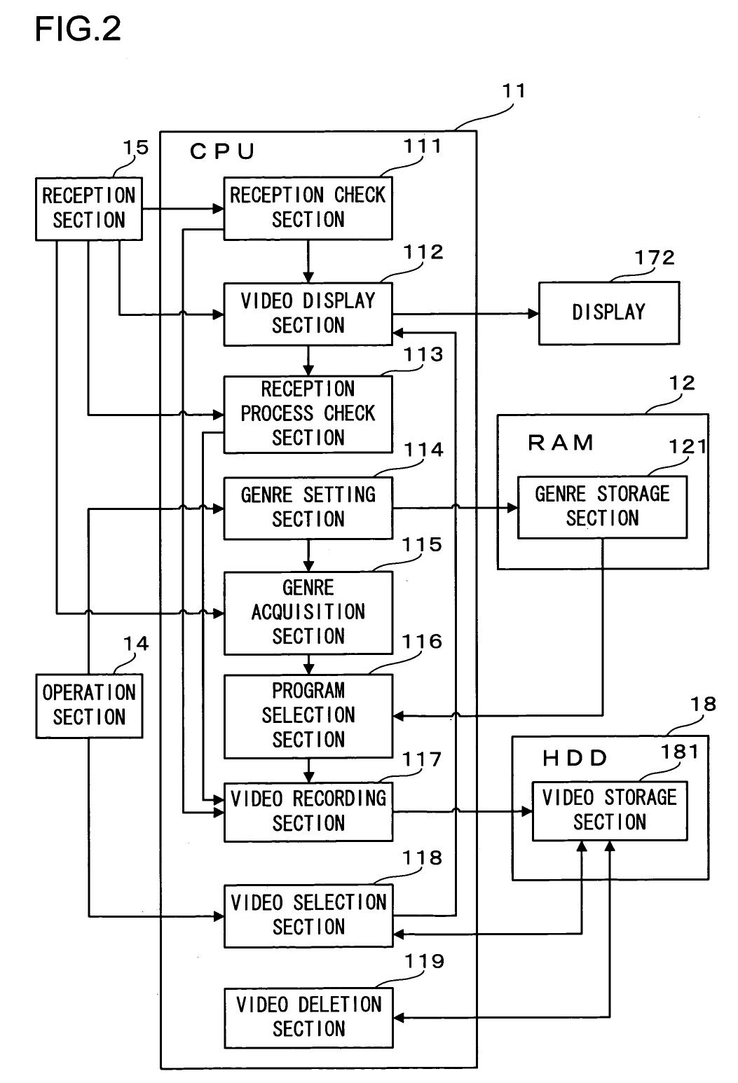

FIG. 2 is a block diagram showing an example of the configuration of main portions of the portable television set 1 according to the present invention. The CPU 11 functionally includes a reception check section 111, a video display section 112, a reception process check section 113, a genre setting section 114, a genre acquisition section 115, a program selection section 116, a video recording section 117, a video selection section 118 and a video deletion section 119. The RAM 12 functionally includes a genre storage section 121. The HDD 18 functionally includes a video storage section 181.

The CPU 11 reads and executes a control program that is previously stored in the ROM 13 or the like shown in FIG. 1, and thereby functions as functional sections such as the reception check section 111, the video display section 112, the reception process check section 113, the genre setting section 114, the genre acquisition section 115, the program selection section 116, the video recording section 117, the video selection section 118, the video deletion section 119. The CPU 11 makes the RAM 12 function as function sections such as the genre storage section 121, and makes the HDD 18 function as function sections such as the video storage section 181.

Of various kinds of data stored in the RAM 12 and ROM 13 shown in FIG. 1, the data that can be stored in a removable storage medium may be readable by a driver such as a hard disk drive, an optical disc drive, a flexible disk drive, a silicon disk drive and a cassette reader. In this case, examples of the storage medium include a hard disk, an optical disc, a flexible disk, a CD (compact disc), a DVD (digital versatile disc) and a semiconductor memory.

The genre storage section 121 stores genre information set by the genre setting section 114. The genre information stored in the genre storage section 121 is written by the genre setting section 114 and is read by the program selection section 116.

The video storage section 181 stores video information received through the reception section 15. The video information stored in the video storage section 181 is written by the video recording section 117 and is read by the video display section 112. The video information stored in the video storage section 181 is deleted by the video deletion section 119.

The reception check section 111 checks whether or not television broadcast can be received through the reception section 15. Specifically, the reception check section 111 detects the reception strength of a television broadcast wave received through the reception section 15 for each of a plurality of predetermined channels (frequency bands), and checks whether or not the television broadcast wave can be received according to whether the reception strength detected is equal to or more than a predetermined threshold. When the reception check section 111 can receive television broadcast on at least one channel (frequency band), it finds that television broadcast can be received; when the reception check section 111 can receive no television broadcast, it finds that television broadcast cannot be received.

The video display section 112 feeds video information received through the reception section 15 to the display 172. The video display section 112 reads, from the video storage section 181, one piece of video information selected by the video selection section 118, and feeds it to the display 172.

The reception process check section 113 checks whether or not television broadcast is being received through the reception section 15. Specifically, the reception process check section 113 checks whether or not television broadcast is being received through the reception section 15 and the video information received by the video display section 112 is being fed to the display 172 (whether or not the video of the television broadcast received through the reception section 15 is being displayed on the display 172 so that the video is viewed by a user).

The genre setting section 114 receives an operational input from a user through the operation section 14, then sets genre information based on the received operational input and then stores the genre information in the genre storage section 121.

The genre acquisition section 115 obtains EPG (electronic program guide) information through the reception section 15, and extracts, from the received EPG information, genre information for receivable programs.

Based on the genre information obtained by the genre acquisition section 115, the program selection section 116 selects, from programs that can be received through the reception section 15, a program having genre information corresponding to the genre information set by the genre setting section 114 (stored in the genre storage section 121).

When there is no program having genre information corresponding to the genre information set by the genre setting section 114 (stored in the genre storage section 121), the program selection section 116 selects one program from the receivable programs according to a predetermined rule (here, randomly selects one program from the receivable programs).

The video recording section 117 receives, through the reception section 15, television broadcast of the program selected by the program selection section 116, and writes the received video information in the video storage section 181.

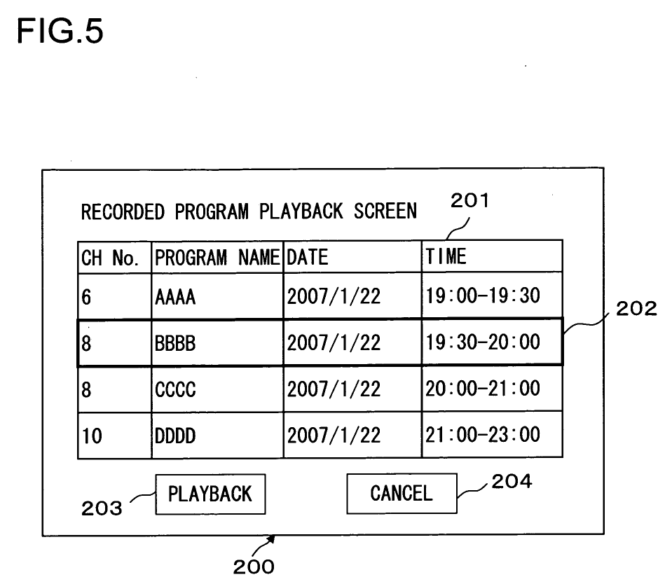

The video selection section 118 selects, based on an operational input received from a user through the operation section 14, one piece of video information from multiple pieces of video information stored in the video storage section 181. Specifically, the video selection section 118 displays on the display 172 a list (a recorded program playback screen 200 shown in FIG. 5) of the multiple pieces of video information stored in the video storage section 181, and selects, based on the operational input received from the user through the operation section 14, one piece of video information from the multiple pieces of video information stored in the video storage section 181.

When the amount of video information stored in the video storage section 181 reaches a predetermined first upper limit (for example, 35 GB), the video deletion section 119 deletes the video information stored in the video storage section 181 in the order in which the video information is stored in the video storage section 181 by the video recording section 117 until the amount of video information stored in the video storage section 181 reaches a predetermined second upper limit (for example, 30 GB) less than the first upper limit.

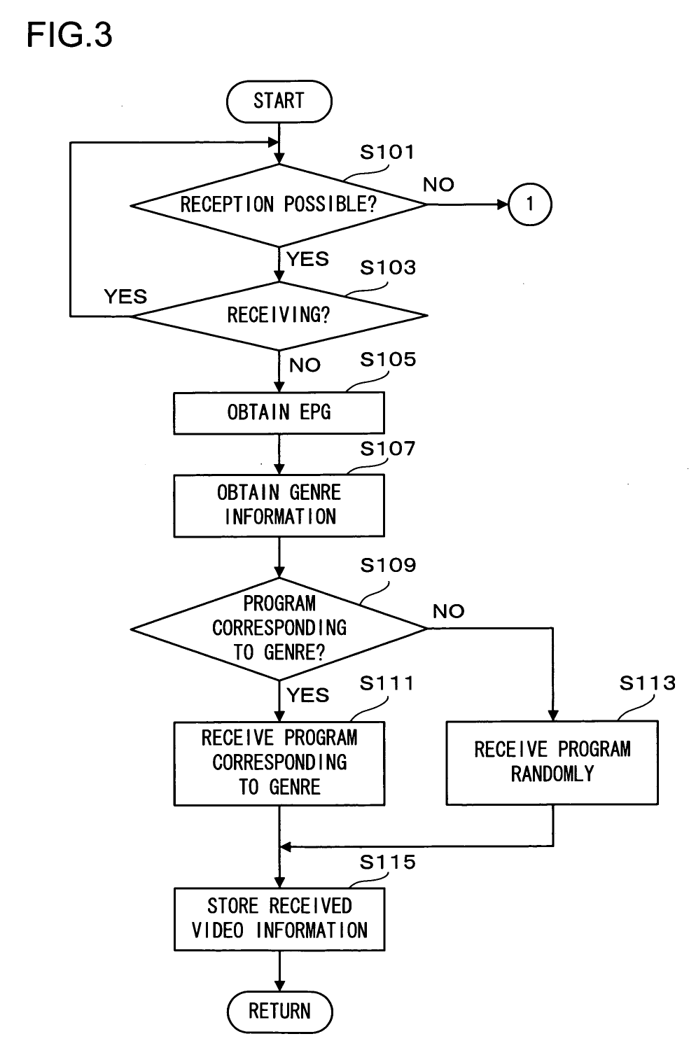

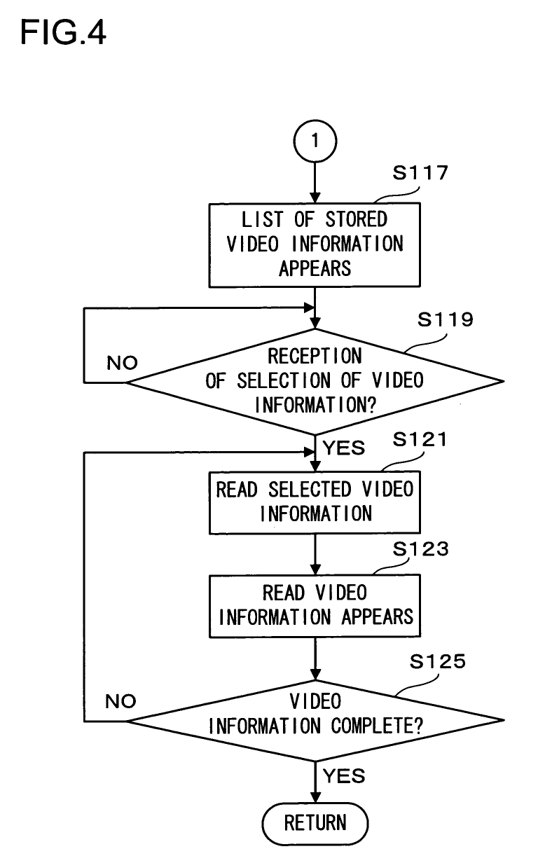

FIGS. 3 and 4 are a flow chart showing an example of the operation of the portable television set 1 (mostly CPU 11). For convenience of description, a description will be given of a case where genre information is previously stored in the genre storage section 121. The reception check section 111 first checks whether or not television broadcast can be received through the reception section 15 (step S101). If television broadcast cannot be received (no in step S101), the process proceeds to step S117 shown in FIG. 4.

If television broadcast can be received (yes in step S101), the reception process check section 113 checks whether or not television broadcast is being received through the reception section 15 (step S103). If television broadcast is found to be being received (yes in step S103), the process returns to step S101, and step S101 and the succeeding steps are repeated. If television broadcast is found not to be being received (no in step S103), the genre acquisition section 115 obtains the EPG information (step S105). Then, the genre acquisition section 115 extracts the genre information of receivable programs from the EPG information obtained in step S105 (step S107).

Then, the program selection section 116 checks whether or not the genre information of the programs extracted in step S107 includes genre information corresponding to the genre information stored in the genre storage section 121 (step S109). If the corresponding genre information is found to be included (yes in step S109), the program selection section 116 selects a program having genre information corresponding to the genre information stored in the genre storage section 121, and the selected program is received through the reception section 15 by the video recording section 117 (step 111). If the corresponding genre information is fount not to be included (no in step S109), the program selection section 116 randomly selects one program from the receivable programs, and the selected program is received through the reception section 15 by the video recording section 117 (step 113). Then, the program received in step S111 or step S113 is written in the video storage section 181 by the video recording section 117 (step 115), and the process returns.

If television broadcast cannot be received in step S101, as shown in FIG. 4, a list (the recorded program playback screen 200 shown in FIG. 5) of multiple pieces of video information stored in the video storage section 181 is displayed on the display 172 by the video selection section 118 (step 117). Then, whether or not a selection of video information by a user is received through the operation section 14 is checked (step 119). If the selection of video information is found not to be received (no in step S119), the process remains in a standby state. If the selection of video information is found to be received (yes in step S119), one piece of video information selected in step S119 is read from the video storage section 181 by the video display section 112 (step S121), and is displayed on the display 172 (step S123). Then, the video display section 112 checks whether or not the playback of the one piece of video information selected in step S119 is complete (step S125). If the playback of the video information is found not to be complete (no in step S125), the process returns to step S121, and step S121 and the succeeding steps are repeated. If the playback of the video information is found to be complete (yes in step S125), the process returns.

FIG. 5 is a screen diagram showing an example of the recorded program playback screen displayed on the display 172 in step S117 in the flow chart shown in FIG. 4. In the recorded program playback screen 200, a video information displayed section 201 appears substantially in the middle thereof, and a playback button 203 and a cancel button 204 appear in the lower portion thereof. In the video information displayed section 201, information of channel numbers, program names, recording dates, recording start times and recording end times corresponding to the video information stored in the video storage section 181 is listed in an organized manner. Of the video information shown in the video information displayed section 201, the selected video information is enclosed by a selection-indication box 202.

A user can select video information that the user desires to play back by shifting the position of the selection-indication box 202 through the operation section 14. The playback button 203 is pressed to play back the video information indicated by the selection-indication box 202. The cancel button 204 is pressed to restore the selected video information to its original state (non-selected state).

As described above, television broadcast is received through the reception section 15, and the received video information is fed to the display 172. Moreover, whether or not television broadcast can be received through the reception section 15 is checked, and whether or not television broadcast is being received through the reception section 15 is checked. Then, if television broadcast is found to be receivable and is found not to be being received, television broadcast on a channel preset through the reception section 15 is received, and the received video information is written in the video storage section 181. Thus, it is possible to record television broadcast with enhanced user convenience.

That is, if television broadcast is found to be receivable and is found not to be being received (if television broadcast can be received but is not being viewed), television broadcast on a channel preset through the reception section 15 is received, and the received video information is written in the video storage section 181; hence, a user does not need to program recording or the like. Thus, it is possible to record television broadcast with enhanced user convenience.

Moreover, an operational input from a user is received through the operation section 14, and based on the received operational input, one piece of video information is selected from multiple pieces of video information stored in the video storage section 181. Then, the one piece of video information is read from the video storage section 181 and is fed to the display 172. Thus, it is possible to view recorded television broadcast programs with enhanced user convenience.

Furthermore, television broadcast is digital television broadcast; an operational input from a user is received through the operation section 14 and genre information is set based on the received operational input. Then, EPG information is obtained through the reception section 15, and the genre information of receivable programs is extracted from the EPG information obtained. Then, based on the genre information obtained, a program having genre information corresponding to preset genre information is selected from receivable programs through the reception section 15, and television broadcast of the selected program is received and the received video information is written in the video storage section 181. Thus, it is possible to record television broadcast with more enhanced user convenience.

That is, based on the genre information obtained, a program having genre information corresponding to preset genre information is selected from programs that can be received through the reception section 15, and television broadcast of the selected program is received and the received video information is written in the video storage section 181; hence, when the genre of programs that a user desires to view is set, programs of the genre desired by the user are recorded. Thus, it is possible to record television broadcast with further enhanced user convenience.

Still furthermore, when the amount of video information stored in the video storage section 181 reaches a predetermined first upper limit (here, 35 GB), the video information stored in the video storage section 181 is deleted in the order in which the video information is stored in the video storage section 181 until the amount of video information stored in the video storage section 181 reaches a predetermined second upper limit (here, 30 GB) less than the first upper limit. Thus, it is possible to record television broadcast with more further enhanced user convenience.

That is, when the amount of video information stored in the video storage section 181 reaches the predetermined first upper limit (here, 35 GB), the video information stored in the video storage section 181 is deleted in the order in which the video information is stored in the video storage section 181 until the amount of video information stored in the video storage section 181 reaches the predetermined second upper limit (here, 30 GB) less than the first upper limit; hence, the amount of video information stored in the video storage section 181 can be regulated to be equal to or more than the second upper limit (here, 30 GB) but equal to or less than the first upper limit (here, 35 GB), and accordingly the capacity of the video storage section 181 can be used effectively. Thus, by appropriately setting the first and second upper limits, it is possible to record television broadcast with still further enhanced user convenience.

Although this embodiment deals with a case where the portable reception device of the present invention serves as a portable television set 1 that receives digital television broadcast, the portable reception device of the invention applies to any other portable television set that is portably designed, and that receives television broadcast and feeds the received video information to a monitor so that the video is viewed from outside. For example, the portable reception device of the invention applies to any mobile telephone that receives television broadcast.

This embodiment deals with a case where a CPU 11 includes function sections such as a reception check section 111, a video display section 112, a reception process check section 113, a genre setting section 114, a genre acquisition section 115, a program selection section 116, a video recording section 117, a video selection section 118 and a video deletion section 119; however, at least one of the function sections of the reception check section 111, the video display section 112, the reception process check section 113, the genre setting section 114, the genre acquisition section 115, the program selection section 116, the video recording section 117, the video selection section 118 and the video deletion section 119 may be formed as hardware such as a circuit.

Although this embodiment deals with a case where a video recording section 181 is functionally included in a HDD 18, the video storage section 181 may be functionally included in any other storage medium (for example, IC memory).

What is claimed is:

1. A portable reception device that is portably designed, and that receives television broadcast and feeds received video information to a monitor so that video is viewed from outside, the portable reception device comprising:
a reception section receiving television broadcast;
a video display section feeding video information received through the reception section to the monitor;
a video storage section storing the video information received through the reception section;
a reception check section checking whether or not television broadcast can be received through the reception section;
a reception process check section checking whether or not television broadcast is being received through the reception section; and
a video recording section receiving television broadcast on a channel preset through the reception section and writing received video information in the video storage section if television broadcast is found to be receivable by the reception check section and is found not to be being received by the reception process check section.

2. The portable reception device of claim 1, further comprising:
a video selection section receiving an operational input from outside and selecting, based on the received operational input, one piece of video information from multiple pieces of video information stored in the video storage section,
wherein the video display section reads, from the video storage section, the one piece of video information selected by the video selection section and feeds the one piece of video information to the monitor.

3. The portable reception device of claim 1,
wherein the television broadcast is digital television broadcast and the portable reception device further comprising:
a genre setting section receiving an operational input from outside and setting genre information based on the received operational input;
a genre acquisition section obtaining EPG (electronic program guide) information through the reception section and extracting genre information of a receivable program from the EPG information obtained; and
a program selection section selecting, based on the genre information obtained by the genre acquisition section, a program having genre information corresponding to the genre information set by the genre setting section from programs that can be received through the reception section, and
wherein the video recording section receives digital television broadcast of the program selected by the program selection section and writes the received video information in the video storage section.

4. The portable reception device of claim 1, further comprising:
a video deletion section deleting, when amount of video information stored in the video storage section reaches a predetermined first upper limit, the video information stored in the video storage section in an order in which the video information is stored in the video storage section by the video recording section until the amount of video information stored in the video storage section reaches a predetermined second upper limit less than the first upper limit.

5. The portable reception device of claim 2,
wherein the television broadcast is digital television broadcast and the portable reception device further comprising:
a genre setting section receiving an operational input from outside and setting genre information based on the received operational input;
a genre acquisition section obtaining EPG (electronic program guide) information through the reception section and extracting genre information of a receivable program from the EPG information obtained; and
a program selection section selecting, based on the genre information obtained by the genre acquisition section, a program having genre information corresponding to the genre information set by the genre setting section from programs that can be received through the reception section, and
wherein the video recording section receives digital television broadcast of the program selected by the program selection section and writes the received video information in the video storage section.

6. The portable reception device of claim 2, further comprising:
a video deletion section deleting, when amount of video information stored in the video storage section reaches a predetermined first upper limit, the video information stored in the video storage section in an order in which the video information is stored in the video storage section by the video recording section until the amount of video information stored in the video storage section reaches a predetermined second upper limit less than the first upper limit.

7. The portable reception device of claim 3, further comprising:
a video deletion section deleting, when amount of video information stored in the video storage section reaches a predetermined first upper limit, the video information stored in the video storage section in an order in which the video information is stored in the video storage section by the video recording section until the amount of video information stored in the video storage section reaches a predetermined second upper limit less than the first upper limit.

8. The portable reception device of claim 5, further comprising:
a video deletion section deleting, when amount of video information stored in the video storage section reaches a predetermined first upper limit, the video information stored in the video storage section in an order in which the video information is stored in the video storage section by the video recording section until the amount of video information stored in the video storage section reaches a predetermined second upper limit less than the first upper limit.
